(19) United States
(12) Patent Application Publication
(10) Pub. No.: US 2022/0181795 A1
(43) Pub. Date: Jun. 9, 2022

(54) DUAL-POLARIZED DIPOLE ANTENNAS HAVING SLANTED FEED PATHS THAT SUPPRESS COMMON MODE (MONOPOLE) RADIATION

(71) Applicant: CommScope Technologies LLC, Hickory, NC (US)

(72) Inventor: Mohammad Vatankhah VARNOOSFADERANI, Plano, TX (US)

(21) Appl. No.: 17/437,347

(22) PCT Filed: Mar. 17, 2020
(86) PCT No.: PCT/US2020/023138

§ 371 Date: Sep. 8, 2021

Related U.S. Application Data
(60) Provisional application No. 62/825,843, filed on Mar. 29, 2019.

(51) Int. Cl. H01Q 25/00; H01Q 1/24

(52) U.S. Cl. CPC H01Q 25/001; H01Q 21/062; H01Q 1/246

(57) ABSTRACT

An antenna includes a box dipole radiating element, which is supported in front of a reflector. The box dipole radiating element has first through fourth feed ports, which extend adjacent first through fourth corners thereof. First through fourth pairs of slanted feed paths are also provided, which are coupled to the first through fourth feed ports. These first through fourth pairs of slanted feed paths extend rearwardly toward the reflector at first through fourth acute angles relative to respective first through fourth sides of the box dipole radiating element, so that: (i) the first and third pairs of slanted feed paths appear to criss-cross each other when a space between the box dipole radiating element and the reflector is viewed in a direction normal to the first side and parallel to the reflector; and (ii) the second and fourth pairs of slanted feed paths appear to criss-cross each other when the space is viewed in a direction normal to the second side and parallel to the reflector.

### FIELD OF THE INVENTION

The present invention relates to radio communications and antenna devices and, more particularly, to dual-polarized antennas for cellular communications and methods of operating same.

### BACKGROUND

Cellular communications systems are well known in the art. In a typical cellular communications system, a geographic area is often divided into a series of regions that are commonly referred to as “cells”, which are served by respective base stations. Each base station may include one or more base station antennas (BSAs) that are configured to provide two-way radio frequency (“RF”) communications with mobile subscribers that are within the cell served by the base station. In many cases, each base station is divided into “sectors.” In perhaps the most common configuration, a hexagonally shaped cell is divided into three 120° sectors, and each sector is served by one or more base station antennas, which can have an azimuth Half Power Beam Width (HPBW) of approximately 65° to thereby provide sufficient coverage to each 120° sector. Typically, the base station antennas are mounted on a tower or other raised structure and the radiation patterns (a/k/a “antenna beams”) are directed outwardly therefrom. Base station antennas are often implemented as linear or planar phased arrays of radiating elements.

Furthermore, in order to accommodate an increasing volume of cellular communications, cellular operators have added cellular service in a variety of frequency bands. While in some cases it is possible to use a single linear array of so-called “wide-band” radiating elements to provide service in multiple frequency bands, in other cases it may be necessary to use different linear arrays of radiating elements in multi-band base station antennas to support service in the additional frequency bands.

One conventional multi-band base station antenna design includes at least one linear array of relatively “low-band” radiating elements, which can be used to provide service in some or all of a 617-960 MHz frequency band. In addition, to reduce costs and provide for more compact antennas, each of these “low-band” radiating elements may be configured to surround a corresponding relatively “high-band” radiating element that is used to provide service in some or all of a 1695-2690 MHz frequency band.

A conventional box dipole radiating element may include four dipole radiators that are arranged to define a box like shape. The four dipole radiators may extend in a common plane, and may be mounted forwardly of a reflector that may extend parallel to the common plane. So called feed stalks may be used to mount the four dipole radiators forwardly from the reflector, and may be used to pass RF signals between the dipole radiators and other components of the antenna. In some of these conventional box dipole radiating elements, a total of eight feed stalks (4×2) may be provided and may connect to the box dipole radiators at the corners of the box.

For example, as illustrated by FIGS. 1A-1B, a conventional multi-band radiator 10 for a base station antenna may include a relatively high-band radiating element 10a centered within and surrounded on four sides by a relatively low-band radiating element 10b, which is configured as a box dipole radiating element (“box dipole”). RF signals may be fed to the four dipole radiators of a conventional box dipole radiating element through the feed stalks at two opposed and “excited” corners of the “box,” as is shown in FIG. 1A. In response, common mode (CM) currents are forced automatically onto the feed stalks at the two diametrically opposed non-excited corners of the box dipole, in response to differential mode (DM) currents that are fed to the two excited “differential mode” ports. And, because these common mode currents radiate as a monopole on these “non-excited” feed stalks, the overall radiation pattern of the box dipole 10b is actually a combination of two dipoles and two monopoles (with “nulls”), as illustrated by the simplified radiation patterns of FIG. 1B. Unfortunately, the radiation stemming from monopole operation can be highly undesirable when designing a box dipole radiator. For example, although having common mode currents radiating at the same time with differential mode currents in the box dipole 10b can be expected to slightly narrow the azimuth HPBW of the box dipole 10b because of the presence of two nulls caused by the monopole radiators, a concurrent co-polarization radiation pattern of the box dipole 10b can be expected to demonstrate rising “shoulders” in the radiation pattern, which refer to radiation emitted outside the main lobe in the azimuth plane. These shoulders can significantly degrade overall antenna performance.

Referring now to FIGS. 2A-2B, conventional cross-polarized box dipole radiating elements 20, 20′ (with inwardly slanted feed stalks and hence slanted monopoles) are illustrated, which operate in a similar manner relative to the low-band radiating element 10b of FIG. 1A. Thus, as shown, the excitation of a first pair of diametrically opposite “differential mode” ports of the box dipole radiating elements 20, 20′ can induce common mode (CM) currents in a corresponding second pair of ports, which results in monopole-type radiation from a pair of slanted monopoles. And, as further shown by FIG. 2A, this monopole-type radiation can result in the generation of undesired “shoulders” (S) in an azimuth radiation pattern associated with the box dipole 20.

### SUMMARY

An antenna according to some embodiments of the invention includes a box dipole radiating element, which is supported at a first distance in front of a reflector. The box dipole radiating element has first through fourth feed ports, which are located at the respective first through fourth corners of the box dipole radiating element. First through fourth pairs of slanted feed paths are also provided, which are electrically coupled to the first through fourth feed ports, respectively. These first through fourth pairs of slanted feed paths extend rearwardly from the feed ports toward the reflector at corresponding first through fourth acute angles relative to respective first through fourth sides of the box dipole radiating element so that: (i) the first and third pairs of slanted feed paths appear to criss-cross each other when a space between the box dipole radiating element and the reflector is viewed in a direction normal to the first side and parallel to the reflector; and (ii) the second and fourth pairs of slanted feed paths appear to criss-cross each other when the space is viewed in a direction normal to the second side and parallel to the reflector.

Based on this configuration, the first and third sides of the box dipole radiating element correspond to opposite sides of the box dipole radiating element, and the first and third ports are located at diametrically opposite corners of the box dipole radiating element. Similarly, the second and fourth sides of the box dipole radiating element correspond to opposite sides of the box dipole radiating element, and the second and fourth ports are located at diametrically opposite corners of the box dipole radiating element. The first through fourth pairs of slanted feed paths may also be configured to at least partially support the box dipole radiating element in front of the reflector.

According to additional embodiments of the invention, the first through fourth pairs of slanted feed paths have respective lengths in a range from about 0.8 times to about 2.0 times a distance to which a frontmost radiating surface of the box dipole radiating element is supported in front of the reflector. The first through fourth pairs of slanted feed paths may also be configured to extend rearwardly at respective first through fourth acute angles in a range from about 30° to about 60° relative to a plane passing through the first through fourth sides of the box dipole radiating element (and parallel to the reflector).

According to further embodiments of the invention, respective first through fourth distal ends of the first through fourth pairs of slanted feed paths extending adjacent the reflector are sufficiently spaced from each other that an area of a largest rectangle extending adjacent a surface of the reflector and defined by the first through fourth distal ends is greater than 80% of a maximum rectangular area defined by first through fourth sides of the box dipole radiating element, and possibly even greater than 100% of the maximum rectangular area. Stated alternatively, the first through fourth distal ends of the pairs of slanted feed paths are sufficiently spaced from each other that a relatively large area on the surface of the reflector is available (without interruption) for mounting an additional radiating element (e.g., a higher frequency cross-polarized dipole radiating element), which can be aligned with a center of the box dipole radiating element.

According to additional embodiments of the invention, a box dipole radiating element of an antenna is provided, which has first through fourth feed ports at respective first through fourth corners thereof. In addition, first through fourth pairs of slanted feed paths are provided, which are electrically coupled to the first through fourth feed ports, respectively. The first pair of slanted feed paths may extend rearwardly at an acute angle relative to a first side of the box dipole radiating element and may each have lengths from about 0.8 times to about 2.0 times a distance to which a frontmost radiating surface of the box dipole radiating element is supported in front of a reflector. This acute angle may be less than 60° relative to a plane that extends parallel to the reflector and passes through all four sides of the box dipole radiating element.

According to still further embodiments of the invention, a box dipole radiating element is provided, which has first through fourth feed ports at respective first through fourth corners thereof. First through fourth pairs of feed path supports are provided, which are electrically coupled to the first through fourth feed ports, respectively. The first through fourth pairs of feed path supports include respective pairs of parallel and slanted feed path segments that extend at an acute angle relative to respective first through fourth sides of the box dipole radiating element. In some of these embodiments of the invention, the first pair of feed path supports extend rearwardly at a first acute angle of less than 60° relative to a plane that passes through all four sides of the box dipole radiating element. The first through fourth pairs of feed path supports may also be configured to at least partially support the box dipole radiating element in front of a reflector. And, advantageously, first through fourth distal ends of the first through fourth pairs of feed path supports extending adjacent the reflector may be sufficiently spaced from each other that an area of a largest rectangle extending adjacent a surface of the reflector and defined by the first through fourth distal ends is greater than 80% of a maximum rectangular area defined by first through fourth sides of the box dipole radiating element. Each of the pairs of slanted feed path supports may also have lengths from about 0.8 times to about 2.0 times a distance to which a frontmost radiating surface of the box dipole radiating element is supported in front of the reflector.

### BRIEF DESCRIPTION OF THE DRAWINGS

FIG. 1A is a schematic diagram of a multi-band radiator including a high-band radiating element surrounded by a low-band box dipole radiating element, showing simulated differential mode and common mode currents therein, according to the prior art.

FIG. 1B illustrates radiation patterns of a dipole antenna having a differential mode (DM) and a monopole antenna having a common mode (CM), which when combined together provide a radiation pattern of a conventional box dipole antenna.

FIG. 2A illustrates a conventional sheet metal box dipole radiating element with slightly slanted corners, and a simulated azimuth radiation pattern having undesired shoulders caused by monopole radiators created by common mode currents on non-excited corners of the box dipole.

FIG. 2B illustrates a conventional dicasted box dipole radiating element with slightly slanted corners, and a simulated azimuth radiation pattern having undesired shoulders caused by monopole radiators created by common mode currents on non-excited corners of the box dipole.

FIGS. 3A-3B are side and plan views of a box dipole radiating element having four pairs of slanted feed paths, according to an embodiment of the present invention.

FIG. 3C is a perspective view of the antenna of FIGS. 3A-3B, which is supported in front of a reflector by four pairs of slanted and parallel feed paths, according to an embodiment of the present invention.

FIG. 3D is a schematic illustration of an excited radiation pattern associated with the antenna of FIGS. 3A-3C, which includes reduced monopole radiation artifacts, according to an embodiment of the invention.

FIG. 3E is a simplified schematic illustration of the box dipole radiating element of FIGS. 3A-3D, which surrounds a relatively high band cross-polarized radiating element, according to an embodiment of the invention.

FIG. 3F is a simplified plan view illustration of a base station antenna having a column of relatively low band and relatively high band radiating elements, according to an embodiment of the invention.

FIG. 3G is a simplified plan view illustration of the box dipole radiating element of FIGS. 3A-3D, which highlights a range of potential directions a plurality of pairs of slanted feed paths may extend relative to respective sides of the box dipole radiating element, according to an embodiment of the invention.

FIG. 4A illustrates simulated azimuth radiation patterns across ±180° (relative to boresight) associated with the antenna of FIGS. 3A-3C, assuming a monopole length of 70 mm (left) and 80 mm (right).

FIG. 4B illustrates simulated azimuth radiation patterns across ±180° (relative to boresight) associated with the antenna of FIGS. 3A-3C, assuming a monopole length of 90 mm (left) and 100 mm (right).

FIG. 4C illustrates simulated azimuth radiation patterns across ±180° (relative to boresight) associated with the antenna of FIGS. 3A-3C, assuming a monopole length of 110 mm (left) and 120 mm (right).

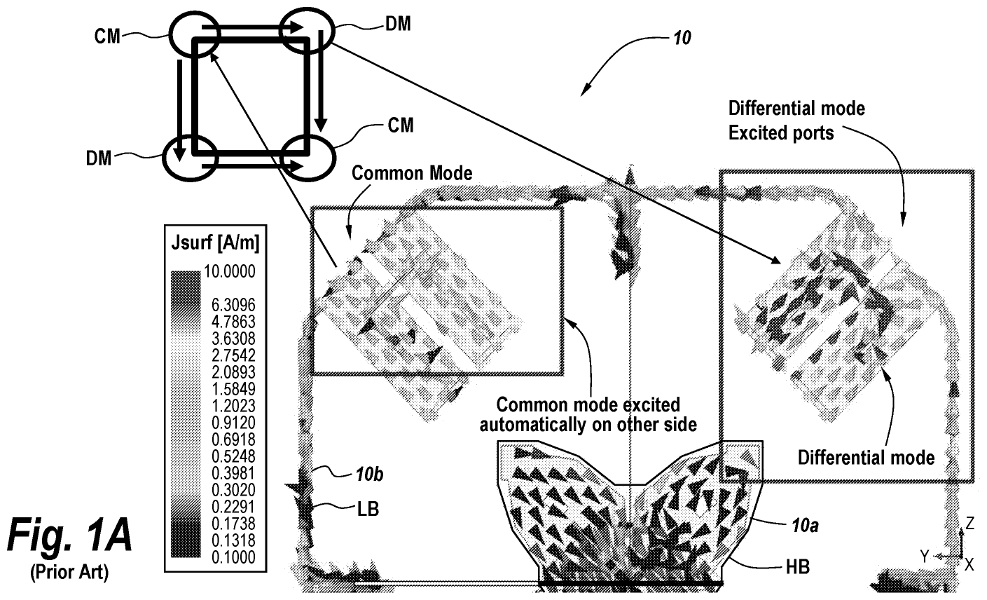

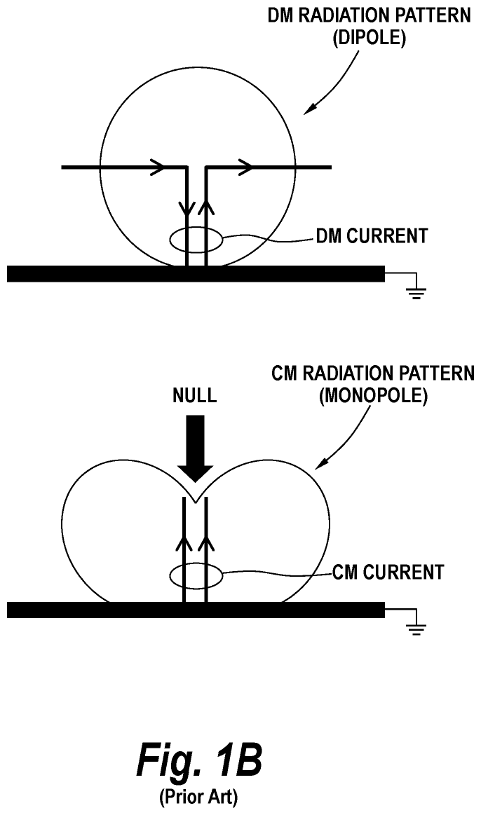

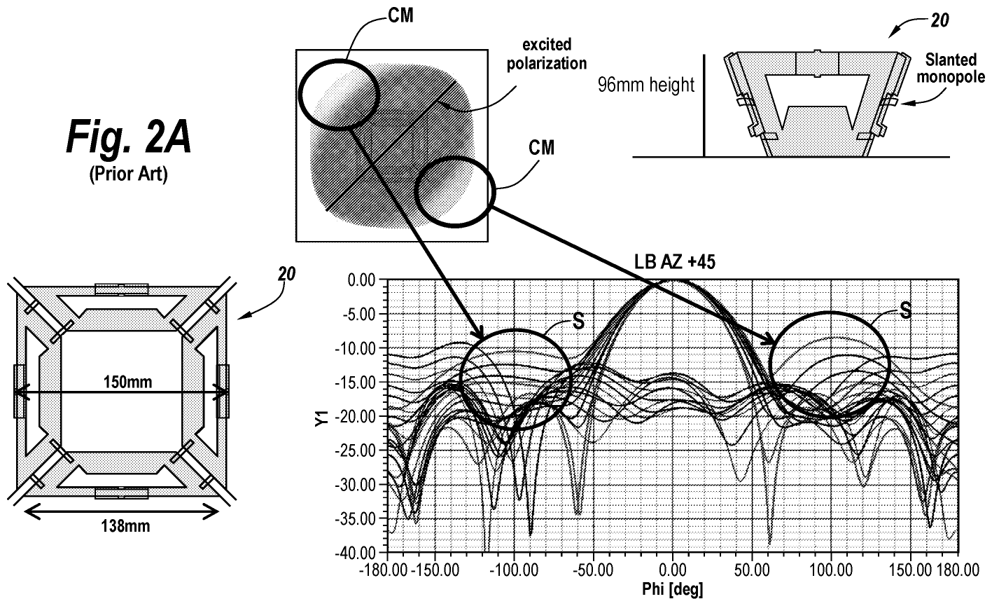

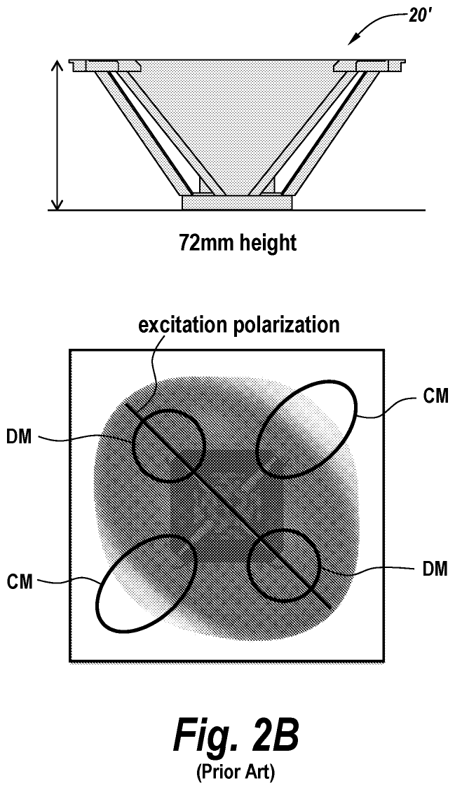

### DETAILED DESCRIPTION OF EMBODIMENTS

The present invention now will be described more fully with reference to the accompanying drawings, in which preferred embodiments of the invention are shown. This invention may, however, be embodied in many different forms and should not be construed as being limited to the embodiments set forth herein; rather, these embodiments are provided so that this disclosure will be thorough and complete, and will fully convey the scope of the invention to those skilled in the art. Like reference numerals refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

It will be understood that when an element is referred to as being “on” another element, it can be directly on the other element or intervening elements may also be present. In contrast, when an element is referred to as being “directly on” another element, there are no intervening elements present. It will also be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between”, “adjacent” versus “directly adjacent”, etc.).

Relative terms such as “below” or “above” or “upper” or “lower” or “horizontal” or “vertical” may be used herein to describe a relationship of one element, layer or region to another element, layer or region as illustrated in the figures. It will be understood that these terms are intended to encompass different orientations of the device in addition to the orientation depicted in the figures.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, operations, elements, and/or components, but do not preclude the presence or addition of one or more other features, operations, elements, components, and/or groups thereof.

Aspects and elements of all of the embodiments disclosed hereinbelow can be combined in any way and/or combination with aspects or elements of other embodiments to provide a plurality of additional embodiments.

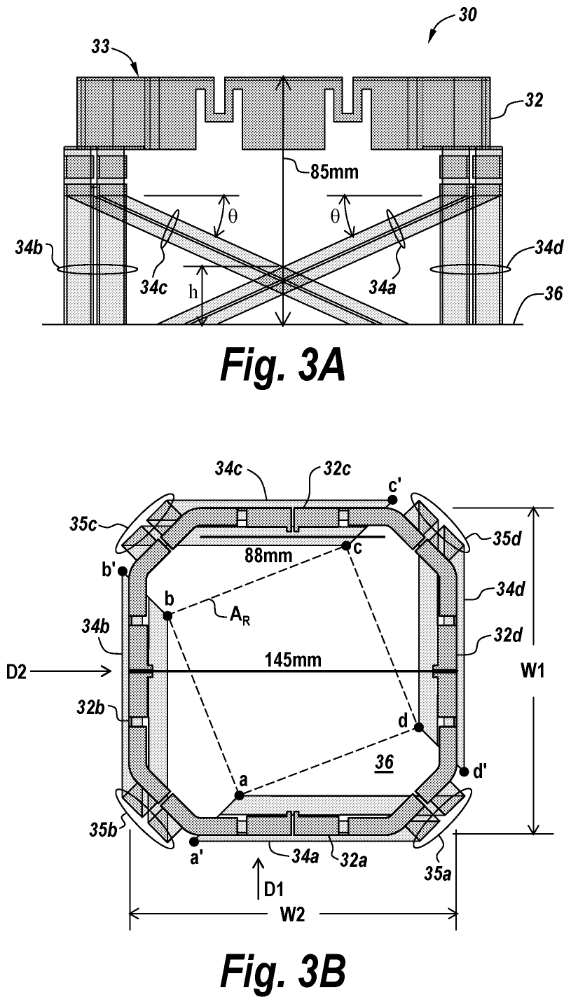

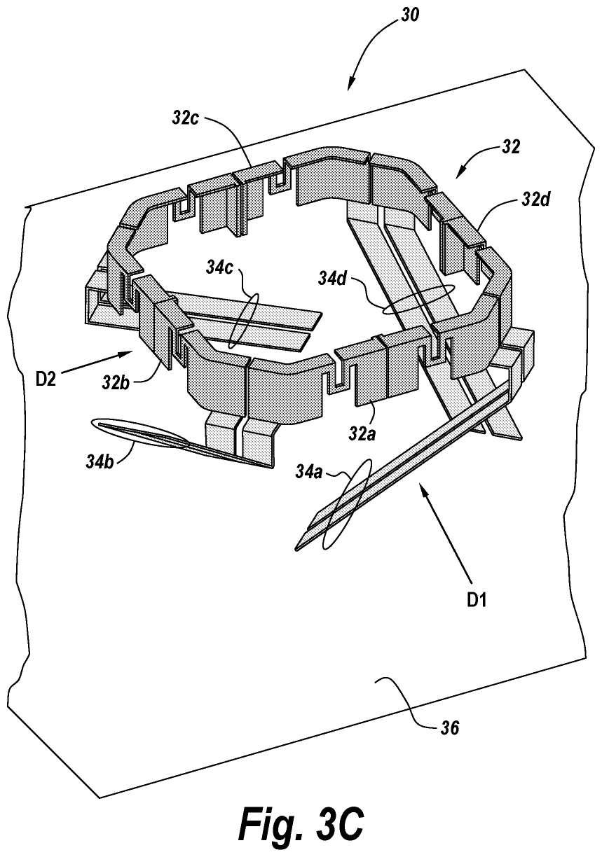

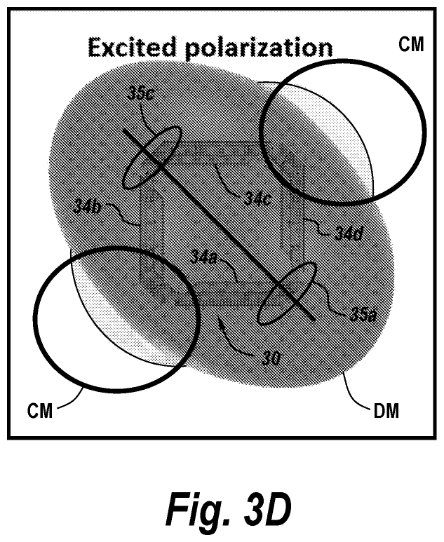

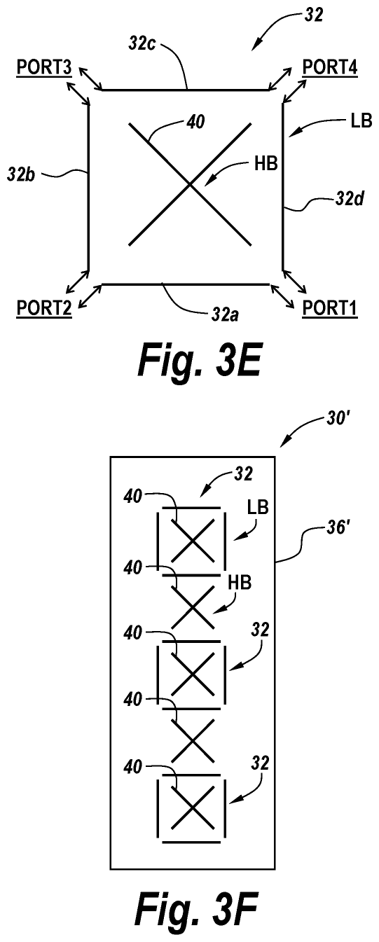

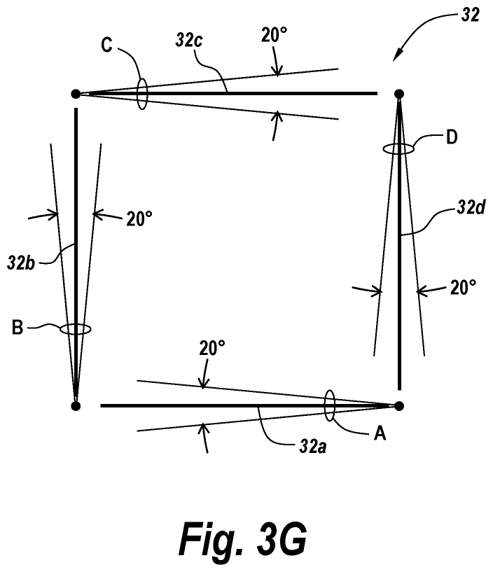

Referring now to FIGS. 3A-3C and 3G, an antenna 30 according to an embodiment of the invention is illustrated as including a box dipole radiating element 32, such as a sheet-metal box dipole radiating element having first through fourth sides 32a-32d. These sides 32a-32d may be aligned along sides of a rectangle, which may be a square having equivalent dimensions W1 and W2 (e.g., 145 mm) in some embodiments of the invention. In alternative embodiments of the invention, the sides 32a-32d may be aligned along respective arcs of a circular loop.

As will be understood by those skilled in the art, the first and fourth sides 32a, 32d define a first dipole radiating element at a first corner, the second and first sides 32b, 32a define a second dipole radiating element at a second corner, the third and second sides 32c, 32b define a third dipole radiating element at a third corner, and the fourth and third sides 32d, 32c define a fourth dipole radiating element at a fourth corner. During operation, the first and third dipole radiating elements (or second and fourth radiating elements) may be excited and the second and fourth dipole radiating elements (or first and third dipole radiating elements) may not be excited. The lack of excitation of the second and fourth dipole radiating elements at the second and fourth corners (or first and third dipole radiating elements at the first and third corners) precludes dipole operation. Nonetheless, currents flowing in the feed lines associated with the second and fourth corners (or first and third corners) act as monopoles when not excited.

As shown, the first dipole radiating element is electrically coupled at a first feed port 35a (at a first corner) to a first pair of slanted and parallel RF signal feed paths 34a, the second dipole radiating element is electrically coupled at a second feed port 35b (at a second corner) to a second pair of slanted and parallel RF signal feed paths 34b, the third dipole radiating element is electrically coupled at a third feed port 35c (at a third corner) to a third pair of slanted and parallel RF signal feed paths 34c, and the fourth dipole radiating element is electrically coupled at a fourth feed port 35d (at a fourth corner) to a fourth pair of slanted and parallel RF signal feed paths 34d.

As shown best by FIGS. 3A and 3C, the first and third pairs of slanted and parallel feed paths 34a, 34c extend rearwardly from the respective first and third feed ports 35a, 35c towards a reflector 36 at corresponding first and third equivalent acute angles “8”. According to some embodiments of the invention, these acute angles may be less than 60° relative to respective first and third sides 32a, 32c of the box dipole radiating element 32.

As illustrated, these acute angles 8 are sufficiently small that the first and third pairs of slanted feed paths 34a, 34c appear to criss-cross each other when a space between the box dipole radiating element 32 and the reflector 36 is viewed in a first direction D1, which is normal to the first side 32a and parallel to the reflector 36, as shown by FIGS. 3B-3C. Likewise, based on the symmetrical arrangement of the four pairs of slanted feed paths 34a-34d, the acute angles 8 are also sufficiently small that the second and fourth pairs of slanted feed paths 34b, 34d appear to criss-cross each other when a space between the box dipole radiating element 32 and the reflector 36 is viewed in a second direction D2, which is normal to the second side 32b and parallel to the reflector 36.

Although not wishing to be bound by any theory, the first pair of criss-crossing feed path pairs 34a, 34c illustrated by FIG. 3A operate to reduce the net monopole radiation caused by the common mode “CM” currents in the first pair of slanted feed paths 34a and the third pair of slanted feed paths 34c, when the second and fourth feed ports 35b, 35d are excited at a first polarization with differential mode currents. Similarly, the second pair of criss-crossing feed path pairs 34b, 34d illustrated by FIG. 3A operate to reduce the net monopole radiation caused by the common mode currents in the second pair of slanted feed paths 34b and the fourth pair of slanted feed paths 34d, when the first and third feed ports 35a, 35c are excited at a second polarization with differential mode currents, as illustrated by FIG. 3D.

As will be understood by those skilled in the art, when the second and fourth feed ports are excited at the first polarization, the common mode currents will travel in a first direction in the first pair of slanted feed paths 34a and in a second “opposing” direction in the third pair of slanted feed paths 34c, when the “monopole” defined by the first pair of slanted feed paths 34a and the “monopole” defined by the third pair of slanted feed paths 34c are viewed in the first direction D1. Similarly, when the first and third feed ports are excited at the second polarization, the common mode currents will travel in a third direction in the second pair of slanted feed paths 34b and in a fourth “opposing” direction in the fourth pair of slanted feed paths 34d, when the “monopole” defined by the second pair of slanted feed paths 34b and the “monopole” defined by the fourth pair of slanted feed paths 34d are viewed in the second direction D2.

Furthermore, to achieve a desired level of reduction in net monopole radiation from a square-shaped box dipole radiating element 32, where W1=W2, a height “h” of intersection between the first and third criss-crossing feed path pairs 34a, 34c and the reflector 36 should be in a predetermined range when a space between the box dipole radiating element 32 and the reflector 36 is viewed in the first direction D1. Similarly, a height “h” of intersection between the second and fourth criss-crossing feed path pairs 34b, 34d and the reflector 36 can be in the same range when the space between the box dipole radiating element 32 and the reflector 36 is viewed in the second direction D2, which is orthogonal to the first direction D1. Moreover, in some additional embodiments of the invention, which may utilize an asymmetric reflector, the first and third criss-crossing feed path pairs 34a, 34c need not be symmetric relative to each other when the first and third feed path pairs have different lengths. Likewise, the second and fourth criss-crossing feed path pairs 34b, 34d need not be symmetric relative to each other when the second and fourth feed path pairs have different lengths.

According to some embodiments of the invention, a desired height “h” of intersection may be achieved when the first through fourth pairs of slanted feed paths 34a-34d have respective “monopole” lengths in a range from about 0.8 times to about 2.0 times a distance to which a frontmost radiating surface 33 of the box dipole radiating element 32 is supported in front of the reflector 36. For purposes of illustration, this distance to the frontmost radiating surface 33 is specified as 85 mm in the antenna embodiment of FIG. 3A. Alternatively, in the event W1≠W2 for the illustrated box dipole radiating element 32 of FIG. 3B, then the heights “h” of intersection may not be equivalent (or in the same range) when the “rectangular” space is viewed in the first direction D1 versus when the corresponding space is viewed in the second direction D2.

According to further embodiments of the invention, an additional advantage to using the first through fourth pairs of slanted feed paths 34a-34d as described hereinabove, is the ability to provide monopole radiation cancellation, but without significantly obstructing the three-dimensional space extending between the box dipole radiating element 32 and the reflector 36. In particular, and as shown best by FIG. 3B, the distal ends of the slanted feed paths 34a-34d are shown to intersect with a surface of the reflector at points “a-a′,” “b-b′,” “c-c” and “d-d′,” which define corners of a relatively large rectangular area Aᵣ on the surface of the reflector that is generally free of hardware associated with supporting and electrically coupling the box dipole radiating element 32 in front of the reflector 36. As used herein, the term “distal end” refers to the portions of the slanted feed paths 34a-34d that extend closely adjacent a forward facing surface of the reflector 36. Although not shown, these ends may be capacitively coupled or otherwise locked (e.g., with plastic components) to the reflector 36 in order to inhibit PIM (passive intermodulation) distortion. In addition, in some embodiments of the invention, balun or other conventional structures/connections (not shown) may be used to provide feed signals to the feed paths 34a-34d.

According to some embodiments of the present invention, the first through fourth pairs of slanted feed paths 34a-34d may be configured so that the rectangular area Aᵣ is greater than about 80% of a maximum rectangular area defined by the first through fourth sides 32a-32d of the box dipole radiating element 32, which in the embodiment of FIG. 3B is equivalent to W1×W2 (i.e., (145 mm)²=210.25 cm²). Advantageously, this large rectangular area Aᵣ supports the placement of a relatively higher band (HB) radiating element therein, without requiring the HB radiating element to be physically spaced from the reflector 36 merely to avoid interference with the four pairs of slanted feed paths 34a-34d. For example, as illustrated by FIG. 3E, a relatively high band cross-polarized radiating element 40 may be provided, which is aligned and centered within the four sides 32a-32d of the box dipole radiating element 32. And, as shown by FIG. 3F, according to one embodiment of the invention, an antenna 30′ may be provided with a linear column of relatively low band (LB) box dipole radiating elements 32, in combination with a collinear column of relatively high band (HB) cross-polarized radiating elements 40, which are directly mounted to a front surface of a reflector 36′.

According to further embodiments of the invention, the first through fourth pairs of slanted feed paths 34a-34d may even be configured so that the rectangular area Aᵣ is greater than about 100% of a maximum rectangular area defined by the first through fourth sides 32a-32d of the box dipole radiating element 32. For example, as shown by FIG. 3G, the first through fourth pairs of slanted and parallel feed paths 34a-34d of FIGS. 3A-3C may be generally aligned, on each side, within respective 20°-40° arcs A, B, C and D. In this manner, the first through fourth pairs of slanted feed paths/segments 34a-34d may extend substantially behind respective first through fourth sides 32a-32d of the box dipole radiating element 32, by extending within the corresponding arcs. These illustrated arcs have respective centers at the first through fourth corners of the box dipole radiating element 32 when the first through fourth pairs of slanted feed paths 34a-34d and first through fourth sides 32a-32d are viewed in a direction normal to a front surface of the box dipole radiating element 32. As shown, each 20° arc may span ±10° relative to a respective one of the first through fourth sides 32a-32d of the box dipole radiating element 32.

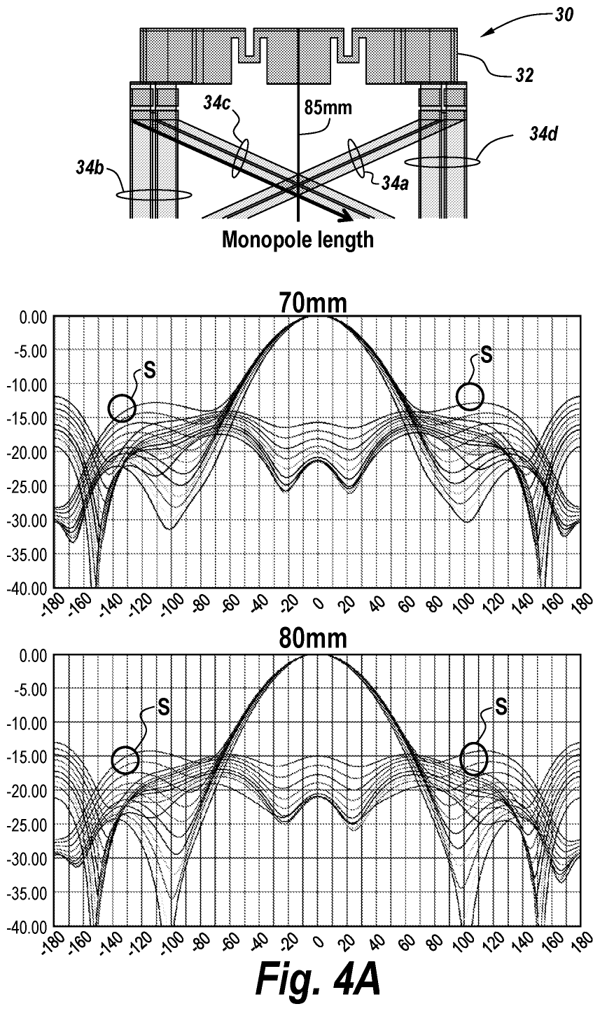

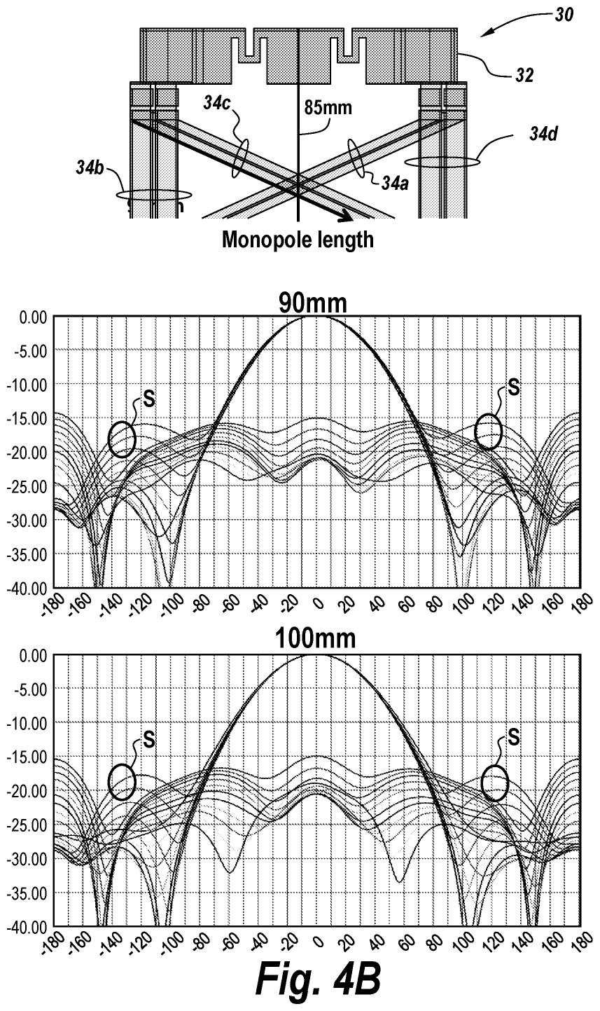

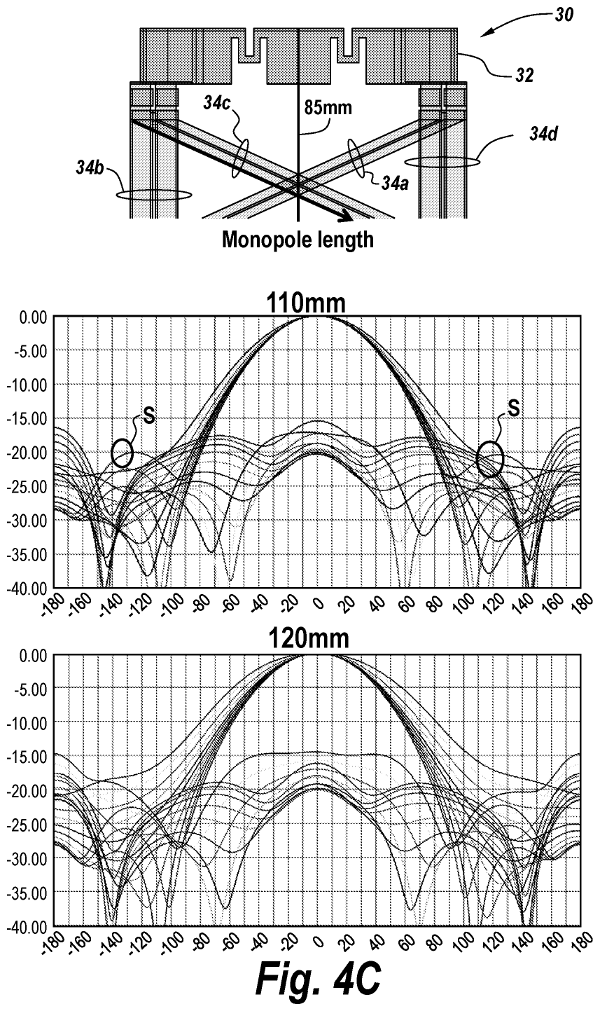

Simulated azimuth radiation patterns associated with the antenna of FIGS. 3A-3C, are provided, which assume: (i) monopole lengths of 70 mm and 80 mm in FIG. 4A, (ii) monopole lengths of 90 mm and 100 mm in FIG. 4B, and (iii) monopole lengths of 110 mm and 120 mm in FIG. 4C. As used herein and highlighted by FIGS. 4A-4C, the term “monopole length” corresponds to the length of the slanted portions of the first through fourth pairs of slanted feed paths 34a-34d illustrated by FIGS. 3A-3C. As can be seen by FIG. 4A, relatively high shoulders “S”, which peak in the −10 dB to −15 dB radiation levels, can be seen in the 70 mm and 80 mm radiation patterns. And, as illustrated by FIG. 4B, somewhat lower shoulders “S”, which peak in the −15 dB to −20 dB radiation levels, can be seen in the 90 mm and 100 mm radiation patterns. Finally, as illustrated by FIG. 4C, significantly reduced shoulders “S”, which peak below the −20 dB radiation level, can be seen in the 110 mm radiation pattern. But, with respect to the 120 mm monopole length example, the spreading in the 120 mm radiation pattern may become excessive. Although not wishing to be bound by any theory, there is a trade-off between the level/height of the shoulders and the consistency of the co-polarization across frequency bands. Thus, whereas the 110 mm radiation pattern may illustrate the lowest level of shoulders, the 100 mm radiation pattern may have a more consistent co-polarization for different frequencies.

In the drawings and specification, there have been disclosed typical preferred embodiments of the invention and, although specific terms are employed, they are used in a generic and descriptive sense only and not for purposes of limitation, the scope of the invention being set forth in the following claims.

1. An antenna, comprising:
a box dipole radiating element supported at a first distance in front of a reflector, said box dipole radiating element having first through fourth feed ports adjacent respective first through fourth corners thereof; and
first through fourth pairs of slanted feed paths electrically coupled to the first through fourth feed ports, respectively, said first through fourth pairs of slanted feed paths extending rearwardly toward the reflector at corresponding first through fourth acute angles relative to respective first through fourth sides of said box dipole radiating element so that: (i) the first and third pairs of slanted feed paths appear to criss-cross each other when a space between said box dipole radiating element and the reflector is viewed in a direction normal to the first side and parallel to the reflector; and (ii) the second and fourth pairs of slanted feed paths appear to criss-cross each other when the space is viewed in a direction normal to the second side and parallel to the reflector.

2. The antenna of claim 1, wherein the first and third sides correspond to opposite sides of said box dipole radiating element; and wherein the first and third ports are on diametrically opposite corners of said box dipole radiating element.

3. The antenna of claim 2, wherein said first through fourth pairs of slanted feed paths are configured to at least partially support said box dipole radiating element in front of the reflector.

4. The antenna of claim 2, wherein said first through fourth pairs of slanted feed paths have respective lengths in a range from about 0.8 times to about 2.0 times a distance to which a frontmost radiating surface of said box dipole radiating element is supported in front of the reflector.

5. The antenna of claim 2, wherein the first pair of slanted feed paths extend rearwardly at a first acute angle relative to a plane passing through the first through fourth sides of said box dipole radiating element.

6. The antenna of claim 5, wherein the first acute angle is in a range from about 30° to about 60°.

7. The antenna of claim 6, wherein respective first through fourth distal ends of said first through fourth pairs of slanted feed paths extending adjacent the reflector are sufficiently spaced from each other that an area of a largest rectangle extending adjacent a surface of the reflector and defined by the first through fourth distal ends is greater than 80% of a maximum rectangular area defined by first through fourth sides of said box dipole radiating element.

8. The antenna of claim 1, wherein respective first through fourth distal ends of said first through fourth pairs of slanted feed paths extending adjacent the reflector are sufficiently spaced from each other that an area of a largest rectangle extending adjacent a surface of the reflector and defined by the first through fourth distal ends is greater than 80% of a maximum rectangular area defined by first through fourth sides of said box dipole radiating element.

9. The antenna of claim 4, wherein respective first through fourth distal ends of said first through fourth pairs of slanted feed paths extending adjacent the reflector are sufficiently spaced from each other that an area of a largest rectangle extending adjacent a surface of the reflector and defined by the first through fourth distal ends is greater than 80% of a maximum rectangular area defined by first through fourth sides of said box dipole radiating element.

10. An antenna, comprising:
a box dipole radiating element having first through fourth feed ports at respective first through fourth corners thereof; and
first through fourth pairs of slanted feed paths electrically coupled to the first through fourth feed ports, respectively, said first pair of slanted feed paths extending rearwardly at an acute angle relative to a first side of said box dipole radiating element and having respective lengths from about 0.8 times to about 2.0 times a distance to which a frontmost radiating surface of said box dipole radiating element is supported in front of a reflector.

11. The antenna of claim 10, wherein each of said first through fourth pairs of slanted feed paths comprises a pair of slanted and parallel feed paths.

12. The antenna of claim 10, wherein each of said first through fourth pairs of slanted feed paths comprises a pair of slanted feed paths having parallel feed path segments therein.

13. The antenna of claim 10, wherein said first through fourth pairs of slanted feed paths are configured to at least partially support said box dipole radiating element in front of the reflector.

14. The antenna of claim 10, wherein said first pair of slanted feed paths extend rearwardly at a first acute angle relative to a plane that extends parallel to the reflector and passes through all four sides of said box dipole radiating element; and wherein the first acute angle is in a range from about 30° to about 60°.

15. The antenna of claim 10, wherein respective first through fourth distal ends of said first through fourth pairs of slanted feed paths extending adjacent the reflector are sufficiently spaced from each other that an area of a largest rectangle extending adjacent a surface of the reflector and defined by the first through fourth distal ends is greater than 80% of a maximum rectangular area defined by first through fourth sides of said box dipole radiating element.

16. An antenna, comprising:
a box dipole radiating element having first through fourth feed ports at respective first through fourth corners thereof; and
first through fourth pairs of feed path supports electrically coupled to the first through fourth feed ports, respectively, said first through fourth pairs of feed path supports comprising respective pairs of parallel and slanted feed path segments that extend at an acute angle relative to respective first through fourth sides of said box dipole radiating element.

17. The antenna of claim 16, wherein said first pair of feed path supports extend rearwardly at a first acute angle of less than 60° relative to a plane that passes through all four sides of said box dipole radiating element.

18. The antenna of claim 16, wherein said first through fourth pairs of feed path supports are configured to at least partially support said box dipole radiating element in front of a reflector; and wherein respective first through fourth distal ends of said first through fourth pairs of feed path supports extending adjacent the reflector are sufficiently spaced from each other that an area of a largest rectangle extending adjacent a surface of the reflector and defined by the first through fourth distal ends is greater than 80% of a maximum rectangular area defined by first through fourth sides of said box dipole radiating element.

19. The antenna of claim 18, wherein said first pair of slanted feed path supports extend rearwardly at an acute angle relative to a first side of said box dipole radiating element and have a length from about 0.8 times to about 2.0 times a distance to which a frontmost radiating surface of said box dipole radiating element is supported in front of the reflector.

20. The antenna of claim 16, wherein said first through fourth pairs of feed path supports are configured to at least partially support said box dipole radiating element in front of a reflector; and wherein said first pair of slanted feed path supports extend rearwardly at an acute angle relative to a first side of said box dipole radiating element and have a length from about 0.8 times to about 2.0 times a distance to which a frontmost radiating surface of said box dipole radiating element is supported in front of the reflector.

21.-25. (canceled)
